(19) United States
(12) Patent Application Publication
(10) Pub. No.: US 2015/0219293 A1
(43) Pub. Date: Aug. 6, 2015

(54) Light-emitting Device Used on Carry-on Article

(71) Applicant: TERRY ELECTRONCS (S.Z) CO., LTD., Baoan District (CN)

(72) Inventors: Benrui Xu, Baoan District (CN); John Gou, Boan District (CN)

(73) Assignee: TERRY ELECTRONCS (S.Z) CO., LTD., Baoan District (CN)

(21) Appl. No.: 14/171,468

(22) Filed: Feb. 3, 2014

(51) Int. Cl. F21L 4/02; F21V 23/00; F21V 33/00; F21V 19/00

(52) U.S. Cl. CPC F21L 4/02; F21V 19/0025; F21V 23/006; F21V 33/0008; F21V 33/0004; F21W 2131/30

(57) ABSTRACT

A light-emitting device used on carry-on article preferably including a movable power, configured to provide a stable power source to a circuit; a control circuit, configured to control a light-emitting component to emit light in a predetermined manner; and at least one circuit of light-emitting component connected with a plurality of illuminants in parallel, and/or wherein the light-emitting component is electrically connected with the control circuit. The plurality of illuminants can be welded on one group of guide line at intervals without shearing the guide line, which may increase the brightness of the light-emitting device, also enable the guide line to have a stronger tensile property, enables the illuminants to emit light vertical to the axial direction of the guide line, and/or to be conveniently installed on the carry-on article to emit light to the lateral side.

### TECHNICAL FIELD

The invention relates to a light-emitting device used on carry-on articles such as clothing, shoes, hat and bags, and in particular, to a light-emitting device which emits light along a direction vertical to the axial direction of a guide line, and has a stronger tensile property.

### BACKGROUND ART

The prior art relates to accessories such as clothing, shoes, other clothes and backpacks on which a light-emitting device is carried. For multiple reasons, shoes and clothing having a flasher have been more popular, where the reasons include safety, noticeable appearances and only the purpose of novelty.

Light-emitting units used for shoes generally includes an optical source, such as one or a plurality of light-emitting diodes; a power, such as a battery; and a switch connecting the power to one or a plurality of lamps. These units usually include electronic circuit components which can control the actual illuminating time of the lamps, thus limiting power consumption and saving the battery. However, a plurality of groups of guide lines are usually led out from the circuit component of the light-emitting devices usually; moreover, an LED illuminant is welded at the end position of each group of guide lines, wherein the light emitting direction of the illuminant is the same with the axial direction of the guide line. All the light-emitting devices have a common defect that each group of guide lines can only be welded with one LED illuminant, which is easy to cause insufficient brightness or single light-emitting pattern, and cannot emit light from the lateral side of the carry-on article.

### SUMMARY OF THE INVENTION

In order to overcome the defects of the prior art, the invention aims at providing a light-emitting device used on carry-out article which enables to connect a plurality of illuminants on each group of guide lines, and can emit light from the lateral side of carry-on clothing

To achieve the above objective, the invention employs the technical scheme as follows:

a light-emitting device on carry-on article, includes:

a movable power, configured to provide a stable power source to a circuit;

a control circuit, configured to control a light-emitting component to emit light in a predetermined manner;

and at least one circuit of light-emitting component connected with a plurality of illuminants in parallel, wherein, the light-emitting component is electrically connected with the control circuit;

the illuminants are vertically welded on the side of a circuit board; electrode terminals of the illuminants penetrate to the other side of the circuit board and are electrically connected with a printed circuit on the circuit board so as to form light-emitting elements; and the light-emitting elements are welded on a guide line having an anode and a cathode in parallel at predetermined intervals.

The guide line is a week current sheathed line which is formed by sticking two pieces of lines together, and is welded on a printed circuit of the circuit board of the light-emitting element after a non-breaking peeling treatment is carried out on positions of the guide line at predetermined intervals; a tubular pinch insulated protective covering is arranged on the position corresponding to the light-emitting element; and a hole for exposing the illuminant is arranged on the tubular wall of the protective covering.

The illuminant is an LED illuminant.

A single tubular pinch insulated protective covering is adopted on the single light-emitting element having a further interval; continuous tubular pinch insulated protective coverings are adopted on a plurality of light-emitting elements having a closer interval; and holes for exposing the illuminants are arranged on the tubular walls of the protective coverings corresponding to the positions of the illuminants.

Since the above technical scheme is adopted, and according to the light-emitting device used on carry-on article of the invention, a plurality of illuminants can be welded on one group of guide line at intervals without shearing the guide line, which not only increases the brightness of the light-emitting device, but also enables the guide line to have a stronger tensile property, and enables the illuminants to emit light vertical to the axial direction of the guide line, and to be conveniently installed on the carry-on article to emit light to the lateral side.

### BRIEF DESCRIPTION OF THE DRAWINGS

FIG. 1 is a schematic structural diagram of the invention;

FIG. 2 is a dissected schematic diagram of a protective covering of a light-emitting element according to the invention; and

FIG. 3 is an enlarged schematic structural diagram of the light-emitting element according to the invention.

### DETAILED DESCRIPTIONS OF THE PREFERRED EMBODIMENTS

The invention is further introduced in details with references to the attached drawings and embodiments.

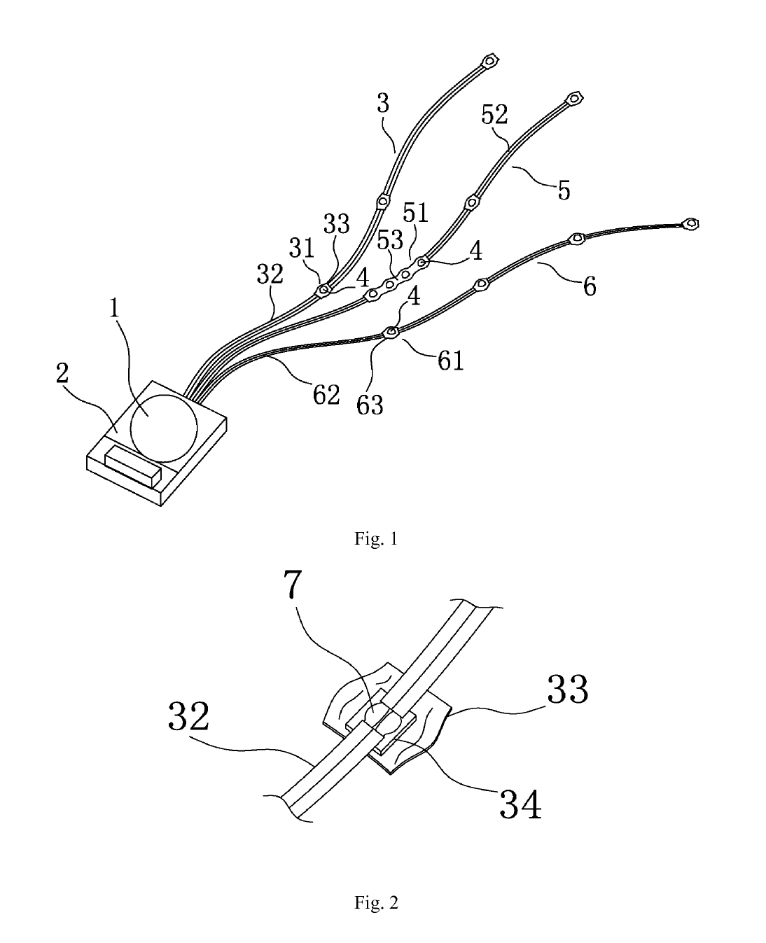

As shown in FIGS. 1-3, a light-emitting device used on carry-on article includes a movable power 1, configured to provide a stable power source to a circuit; a control circuit 2, configured to control a light-emitting component to emit light in a predetermined manner; and at least one circuit of light-emitting component 3 connected with a plurality of illuminants 4 in parallel, wherein the light-emitting component 3 is electrically connected with the control circuit 2.

In the embodiment, three light-emitting components 3, 5 and 6 are introduced in details, and a light-emitting element 31 is taken as an example to explain the structure of the light-emitting element. The illuminants 4 are vertically welded on the side of a circuit board 34; electrode terminals 36 of the illuminants 4 penetrate to the other side of the circuit board 34 and are electrically connected with a printed circuit on the circuit board so as to form light-emitting elements 31; and the light-emitting elements 31 are welded on a guide line 32 having an anode and a cathode in parallel at predetermined intervals.

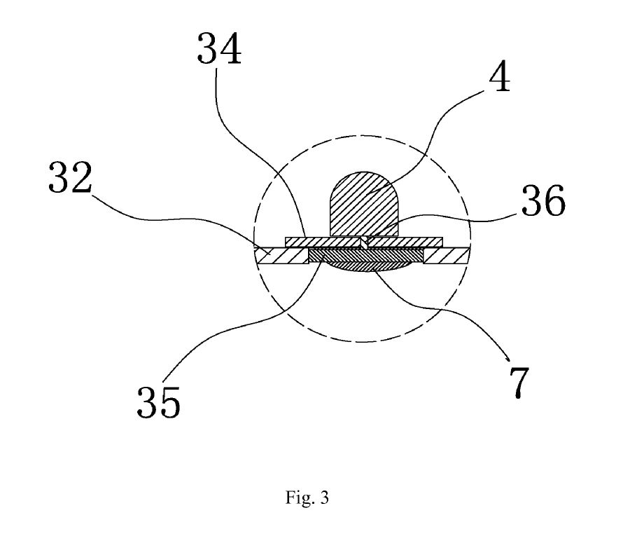

As shown in FIG. 3, the guide line 32 is a week current sheathed line which is formed by sticking two pieces of lines together, and is welded on a printed circuit of the circuit board 34 of the light-emitting element 31 through soldering tin 7 after a non-breaking peeling treatment (a conductive metal wire 35 is not sheared) is carried out on positions of the guide line at predetermined intervals; in this way, the tensile property of the guide line can be enhanced. A tubular pinch insulated protective covering 33 is arranged on the position corresponding to the light-emitting element 31; and a hole for exposing the illuminant is arranged on the tubular wall of the protective covering 33. LED illuminants are generally used as the illuminants 4.

A single tubular pinch insulated protective covering is adopted on the single light-emitting element having a further interval, such as a light-emitting component 3 and a light-emitting component 6. The light-emitting component 3 includes the guide line 32, a plurality of light-emitting elements 31 connected in parallel, and the tubular pinch insulated protective covering 33. The light-emitting component 6 includes a guide line 62, a plurality of light-emitting elements 61 connected in parallel, and a tubular pinch insulated protective covering 63. Continuous tubular pinch insulated protective coverings are adopted on a plurality of light-emitting elements having a closer interval, such as light-emitting component 5, which includes a guide line 52, a plurality of light-emitting elements 51 connected in parallel, and a tubular pinch insulated protective covering 53. Holes for exposing the illuminants are arranged on the tubular walls of the protective coverings corresponding to the positions of the illuminants.

What is claimed is:

1. A light-emitting device used on carry-on article, comprising:
a movable power, configured to provide a stable power source to a circuit;
a control circuit, configured to control a light-emitting component to emit light in a predetermined manner; and
and at least one circuit of light-emitting component connected with a plurality of illuminants in parallel, wherein the light-emitting component is electrically connected with the control circuit;
the illuminants are vertically welded on the side of a circuit board; electrode terminals of the illuminants penetrate to the other side of the circuit board and are electrically connected with a printed circuit on the circuit board so as to form light-emitting elements; and the light-emitting elements are welded on a guide line having an anode and a cathode in parallel at predetermined intervals.

2. The light-emitting device used on carry-on article according to claim 1, wherein the guide line is a week current sheathed line which is formed by sticking two pieces of lines together, and is welded on a printed circuit of the circuit board of the light-emitting element after a non-breaking peeling treatment is carried out on positions of the guide line at predetermined intervals; a tubular pinch insulated protective covering is arranged on the position corresponding to the light-emitting element; and a hole for exposing the illuminant is arranged on the tubular wall of the protective covering.

3. The light-emitting device used on carry-on article according to claim 2, wherein the illuminant is an LED illuminant.

4. The light-emitting device used on carry-on article according to claim 2, wherein a single tubular pinch insulated protective covering is adopted on the single light-emitting element having a further interval; continuous tubular pinch insulated protective coverings are adopted on a plurality of light-emitting elements having a closer interval; and holes for exposing the illuminants are arranged on the tubular walls of the protective coverings corresponding to the positions of the illuminants.
